(19) United States
(12) Patent Application Publication
(10) Pub. No.: US 2026/0251193 A1
(43) Pub. Date: Aug. 27, 2026

(54) ELECTROMECHANICAL BRAKE DEVICE

(71) Applicant: Continental Automotive Technologies GmbH, Hannover (DE)

(72) Inventors: Andreas Kircher, Darmstadt (DE); Johann Jungbecker, Badenheim (DE); Peter Schack, Seligenstadt (DE); Andreas Schirling, Darmstadt (DE)

(73) Assignee: Continental Automotive Technologies GmbH, Hannover (DE)

(21) Appl. No.: 18/871,040

(22) PCT Filed: Apr. 18, 2023
(86) PCT No.: PCT/DE2023/200079

§ 371 Date: Dec. 2, 2024

(30) Foreign Application Priority Data
Jun. 2, 2022 (DE) 10 2022 205 634.5

(51) Int. Cl. F16D 65/18; F16D 51/00; F16D 51/20; F16D 55/226; F16D 65/22; F16D 66/00; F16D 121/24; F16D 125/18; F16D 125/40; G01L 1/22

(52) U.S. Cl. CPC F16D 65/18; F16D 55/226; F16D 66/00; G01L 1/22; F16D 2051/001; F16D 51/20; F16D 65/22; F16D 2066/005; F16D 2121/24; F16D 2125/18; F16D 2125/40

(57) ABSTRACT

An electromechanical brake device for a motor vehicle; having an electric motor drive for the provision of a torque is provided. A transmission assembly for converting the torque into an application force acting along the application direction of the brake device is provided. A support device for supporting the transmission assembly counter to the application direction, and a clamping device for converting the force acting along the application direction into a clamping force acting on an element to be decelerated is provided. The support device may have a force-measuring device for measuring a force acting on the support device along the application direction, wherein the support device has a preloading device, wherein, A preloading device of the support device together with the transmission assembly subjects the force-measuring device to a force acting along the application direction—even in the absence of a force generated by the electric motor.

### TECHNICAL FIELD

The invention relates to a support device and an electromechanical brake device.

### BACKGROUND

Brake devices of this kind, e.g. in the form of a disk brake or floating caliper brake, are known in the prior art. By way of example, reference may be made here to DE 10 2017 206 798 A1 of the applicant. In contrast to the case of a conventional hydraulic brake, in an electromechanical brake device a force in the direction of the respective friction partner is applied to brake linings by means of an electromechanical clamping device in order to generate the desired deceleration torque. In the case of a hydraulic brake, the control of the generated braking torque is effected via the fluid pressure, applied to generate the braking torque, in the brake fluid. However, in the case of an electromechanical brake of the structure described, this is not possible.

Instead, different methods are usually adopted in the prior art in order to calculate the clamping force applied by an electromechanical brake and, using this information, to control the actuation of the electromechanical brake on the basis of a braking requirement. For this purpose, recourse is often had to force sensors that measure a clamping force produced by the brake device. On the basis of a clamping force measured in this way, the brake device can be controlled in accordance with a braking requirement. At this point, it may be mentioned that, within the context of the present application, no distinction is drawn between the terms open-loop control and closed-loop control. The sense of the corresponding terms will be apparent from the respective context.

In this case, the force sensor likewise performs the important task of enabling determination of the piston position by sensing a rise in the applied clamping force when the release clearance of the brake device, i.e. the initial spacing between the friction lining and the brake disk, has been crossed and the lining comes into contact with the disk. In general, the resolution decreases close to the zero point when the measurement range of a force sensor is relatively large. Given inadequate resolution in the region of contact between the friction linings and the brake disk, it is therefore not always possible to reliably ensure that the brake disk is free from residual torque, i.e. that the friction linings are no longer bearing on the brake disk.

In this context, corresponding force sensors are generally arranged in the force flow between the drive, that is to say normally an electric motor, and the clamping device. For functional reasons, the contact surfaces between the force sensor and the corresponding components of the brake device are, on the one hand, never manufactured with an ideal accuracy and, furthermore, plastic deformations occur in the contact surfaces during the operation of the brake device, and these result in slightly different contact points and thus force conditions in each new load cycle. This leads to measurement inaccuracies in the low force range.

### SUMMARY

It is accordingly the underlying object to specify a brake device such that measurement inaccuracies in the low force range are avoided.

This is achieved by means of a support device, for example for supporting a transmission assembly of an electromechanical brake device for a motor vehicle counter to an application direction, and by a brake device having a support device of this kind.

Accordingly, one aspect, can provide a support device, for example for supporting a transmission assembly of an electromechanical brake device for a motor vehicle counter to an application direction, having a clamping device for converting the force acting along the application direction into a clamping force acting on an element to be decelerated.

The support device can be characterized in that the support device has a force-measuring device for measuring a force acting on the support device along the application direction, wherein the support device has a preloading device, wherein, even in the absence of a force generated by the electric motor drive together with the transmission assembly and acting along the application direction, the preloading device subjects the force-measuring device to a force acting along the application direction.

In an electromechanical brake device for a motor vehicle, having an electric motor drive for the provision of a torque, a transmission assembly for converting the torque into an application force acting along the application direction of the brake device, a support device for supporting the transmission assembly counter to the application direction, and a clamping device for converting the force acting along the application direction into a clamping force acting on an element to be decelerated, it is envisaged according to the invention that the support device has a force-measuring device for measuring a force acting on the support device along the application direction, wherein the support device has a preloading device, wherein, even in the absence of a force generated by the electric motor drive together with the transmission assembly and acting along the application direction, the preloading device subjects the force-measuring device to a force acting along the application direction.

The electromechanical brake device can be, for example a service brake in the form of a floating caliper disk brake. In the case of such a brake, a brake caliper is mounted in a brake caliper holder in such a way as to be movable along an application direction, wherein the electric motor drive is usually arranged on the brake caliper. During the operation of such a brake, a first friction lining is moved relative to the brake caliper along the application direction until the friction lining enters into contact with a brake disk, which, in turn, is connected for conjoint rotation to the wheel to be decelerated. If, from this point, the friction lining continues to be subjected to a force in the direction of the brake disk, this causes a movement of the brake caliper counter to the application direction, with the result that a second friction lining arranged opposite the first friction lining in the brake caliper is moved in the direction of the brake disk. As soon as both friction linings are in contact with the brake disk, further application of a linear force in the application direction, i.e. in the direction of the brake disk, to the first friction lining results in an application force on the brake disk. The application force and the ensuing friction between the friction linings and the brake disk results in a torque being exerted on the brake disk, counteracting the rotation of the brake disk.

Accordingly, the “application direction” denotes the direction in which subjecting the friction partners of the brake to a force leads to an increase in the acting application force.

In another embodiment, the use of the support device on or with a drum brake is envisaged. In this case, the friction lining is typically pushed against an encircling drum from the inside. The support device can be arranged between the two brake shoes, for example.

For the sake of simplicity, the following remarks refer essentially to a disk brake, but this should not be considered to restrict the embodiments.

Here, the integration of a preloading device in the support device, such that a defined force acts on the force sensor even when the brake device is not actuated, such that a defined starting point for force measurement can be generated, and this can be allowed for in the form of a constant offset during the effective operation of the brake device. In this way, it is accordingly also possible to accurately measure the range of small clamping forces, thus making it possible to reliably detect a transition from an acting clamping force to a release position by the production of a release clearance.

For this purpose, the preloading device can comprise at least one spring element, which is designed to apply a preloading force, for example in the axial direction. Here, the spring element can comprise at least one compression spring, for example a helical spring or a Belleville spring.

The support device may have a ring-shaped body and an axial bearing ring, wherein the ring-shaped body is supported counter to the application direction on a housing of the brake device, and wherein the axial bearing ring is supported counter to the application direction on the ring-shaped body via the force-measuring device.

Here, the elements mentioned are embodied as a coherent assembly, thus enabling the support device with the force-measuring device contained therein to be pre-assembled even before the assembly of the brake device and then to be inserted into the brake device. In this way, calibration of the force-measuring device can be carried out even before assembly, making it easier to assemble the brake device and, for example, to check the operation of the fully assembled brake device. Accordingly, it is possible, even before assembly, to determine an offset by which clamping forces determined by the force-measuring device must be corrected to ensure that the preloading force of the preloading device is correctly taken into account.

It has already been stated above that the transmission assembly is designed to convert a torque produced by the electric motor drive into a linear force. For this purpose, it is envisaged according to another embodiment that the transmission assembly has a spindle drive with a threaded spindle and a spindle nut secured against rotation about the threaded spindle, wherein the spindle nut is supported counter to the application direction on the support device. Consequently, a rotation of the threaded spindle is converted into a translation of the spindle nut along the threaded spindle, with the result that a torque acting on the threaded spindle is also converted into a linear acting force. In this case, a pressure piston can be arranged on the spindle nut, for example, wherein the pressure piston, in turn, carries a first friction lining and is guided along the application direction in the brake device.

Here, the force exerted on the friction lining via the spindle nut leads, in the example of a floating caliper disk brake, to an application force that acts on a brake disk. The force brought about during this process acts equally on the support of the threaded spindle, thus enabling the acting application force to be directly determined by measurement of precisely this force.

The transmission assembly may be in this case designed as a ball screw, thus minimizing frictional losses and ensuring efficient operation of the brake device.

In this context, attention is drawn to the fact that designation as a “ring” in the case of the elements axial bearing ring and ring-shaped body should not necessarily be interpreted as restricting to a circular geometry. On the contrary, the geometry of the axial bearing ring and of the ring-shaped body must merely ensure correct functioning of the brake device. Since a threaded spindle of the kind introduced above is usually passed centrally through the support device, all that is required here is to provide a corresponding aperture in the axial bearing ring and the ring-shaped body, through which the threaded spindle can be passed.

In the described embodiment of the transmission assembly, frictional losses within the brake device can be minimized according to one embodiment by arranging a roller bearing between the axial bearing ring and the threaded spindle, wherein the threaded spindle is supported counter to the application direction on the roller bearing. For example, the roller bearing can be a multi-row roller bearing, and it is therefore possible to take account of the different peripheral speeds along the radial extent of the bearing by means of corresponding roller bearings of different radii.

According to an embodiment, it is furthermore envisaged that a clamping ring, for example a Belleville spring, is arranged between the ring-shaped body and the axial bearing ring, wherein the clamping ring subjects the axial bearing ring to a force in the direction of the force-measuring device. Here, the force acting on the force-measuring device when the brake device is not being actuated is selected by means of the design of the clamping ring and by means of the corresponding assembly position of the clamping ring relative to the force-measuring device in the support device.

To secure the clamping ring within the support device and to avoid displacement of the clamping ring in the application direction, it is envisaged according to another embodiment that the clamping ring is secured along the application direction by a retaining ring, wherein the retaining ring is arranged at least partially in an encircling groove in an inner wall of the ring-shaped body. In this way, the clamping ring is fixed in one direction on the ring-shaped body, ensuring that the action of the force of the clamping ring on the force-measuring device is supported by the support of the clamping ring on the ring-shaped body. Here, it is possible, for example, for the retaining ring to be in the form of a snap ring, thereby facilitating the fastening of the clamping ring in the ring-shaped body.

According to another embodiment, a defined spring behavior and consequently a constant initial force in the unactuated state is ensured here by virtue of the fact that an encircling ring-shaped collar is formed on the axial bearing ring, wherein the ring-shaped collar extends in the application direction and delimits the radial extent of the clamping ring.

To measure a force, it is usually necessary to have recourse to measurement of some other physical variable that undergoes a change due to the action of a force, since direct measurement of a force is not possible. For this purpose, according to another embodiment, it is envisaged that the force-measuring device has a carrier body, wherein the carrier body rests, on the one hand, on a first bearing surface of the ring-shaped body and, on the other hand, on a second bearing surface of the axial bearing ring, wherein a sensor device is arranged on or in the carrier body, wherein the sensor device is designed to measure a deformation of the carrier body due to the action of a force. In this case, the bearing surfaces and the carrier body per se are of ring-shaped design, thus enabling a threaded spindle of the transmission assembly to be passed through the carrier body. By means of appropriate design of the geometry of the carrier body and of the bearing surfaces, it is possible here to ensure that the carrier body bends when subjected to the action of an axial force. This deformation, in turn, can be detected by strain gauges, for example. Given a knowledge of the bending behavior of the carrier body, it is then possible to determine the acting force directly from the measured deformation or strain of a portion of the carrier body and hence to determine the clamping force acting in the brake device.

Here, introduction of a force into the carrier body in a manner that is uniform and, for example, remains constant over many load cycles is achieved according to another embodiment by the fact that raised portions that project in the axial direction and taper to a point in the axial direction are formed on the carrier body, wherein a first one of the raised portions is formed on a surface of the carrier body which faces the axial bearing ring, and a second of the raised portions is formed on a surface of the carrier body which faces the ring-shaped body, wherein the geometry of the first raised portion differs from the geometry of the second raised portion. Here, the raised portions may be likewise ring-shaped and are, for example, in the form of jags in the axial direction. In the case of a ring-shaped design of the raised portions, a bending moment on the carrier body can be brought about here if the diameter of the first raised portion differs from the diameter of the second raised portion, wherein the first raised portion and the second raised portion may be arranged concentrically. Such a ring-shaped raised portion tapering in the form of a jag is also referred to below as a ring-shaped jag.

Here, the alignment of the elements of the support device relative to one another is made easier according to another embodiment by the fact that a groove matched to the geometry of the first raised portion is formed in the axial bearing ring on the surface facing the carrier body, wherein the first raised portion is supported in the groove. In the case of a ring-shaped jag, easy centering of the force-measuring device in the support device can be achieved in this way. Moreover, displacement of the elements of the support device relative to one another due to the action of a force is avoided.

### BRIEF DESCRIPTION OF THE DRAWINGS

The embodiments will be explained in detail below with the aid of the drawings. In the drawings:

FIG. 1 shows a perspective view of an exemplary electromechanical brake device,

FIG. 2 shows a sectioned detail view of the exemplary brake device,

FIG. 3 shows a perspective view of the region shown in FIG. 2,

FIG. 4 shows schematic illustrations of the force flows within the support device,

FIG. 5 shows a schematic illustration of the mode of operation of the force-measuring device,

FIG. 6 shows a schematic illustration of an embodiment of the force-measuring device,

FIG. 7a shows a schematic sectional view of a support device,

FIG. 7b shows a further schematic sectional view of the support device from FIG. 7a, and

FIG. 8 shows a schematic sectional view of a drum brake with a support device.

### DETAILED DESCRIPTION

In the following text, features that are similar or identical to each other are denoted by the same reference signs.

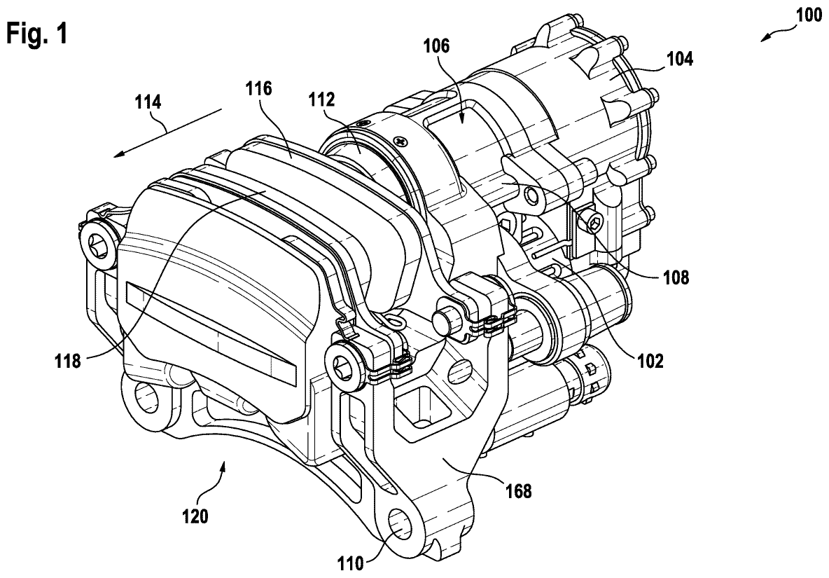

FIG. 1 shows a perspective view of an exemplary electromechanical brake device 100 which is designed in the embodiment illustrated here as a floating-caliper disk brake. The brake device 100 has an electric motor drive in the form of an electric motor 102, which is connected via a first transmission stage 104 for offsetting the rotation axis to a transmission assembly 106, which is designed in the embodiment illustrated here as a rotation-translation mechanism in the form of a spindle drive.

The assembly consisting of the electric motor 102, transmission stage 104, and transmission assembly 106 is here arranged on a housing in the form of a brake caliper 108, which can be fastened to the wheel suspension of a vehicle via a floating mounting in a brake caliper holder 168 having corresponding fastening points 110. A pressure piston 112 is arranged in the brake caliper 108 in such a way that the pressure piston 112 can be moved along an application direction 114 by a corresponding activation of the electric motor 102 and a resulting actuation of the transmission assembly 106.

A first friction lining 116, which is moved toward a second friction lining 118 when the pressure piston 112 moves in the application direction 114, is in turn arranged on the pressure piston 112. If the brake device 100 is fitted on a vehicle, a brake disk rigidly connected to the vehicle wheel is moreover arranged between the friction linings 116 and 118 such that the first friction lining 116 comes into contact with the brake disk in the case of sufficient displacement of the first friction lining 116 in the application direction. If the transmission assembly 106 is actuated further, the second friction lining 118 is moved counter to the application direction 114, i.e. toward a brake disk arranged between the friction linings 116 and 118, until the two friction linings 116 and 118 bear against the brake disk.

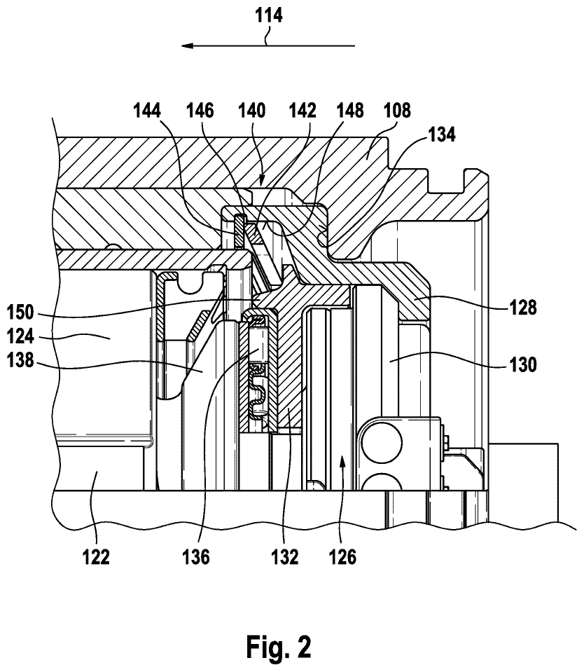

Beyond this point, when the transmission assembly 106 is actuated further, the friction linings 116 and 118 are pressed with a defined and controllable clamping force against the brake disk such that a deceleration torque which slows down the vehicle is applied to the vehicle wheel. Accordingly, the brake caliper 108 with the pressure piston 112 and the brake linings 116 and 118 arranged thereon forms a clamping device 120, which is designed to convert a force acting along the application direction 114 into a clamping force which acts on an element to be decelerated, e.g. a brake disk. In order to control such an electromechanical brake device 100 to implement a defined braking requirement, it is necessary here to calculate precisely with what force the friction linings 116 and 118 are pressed against the brake disk. For this purpose, use is generally made of a force sensor, which is arranged in the force path between the electric motor 102 and the clamping device 120. This is explained below with reference to FIG. 2.

FIG. 2 here shows a view in section of a segment of the exemplary brake device 100. This shows a region in which a force acting along the application direction 114, which is produced in the transmission assembly 106 by the combination of a threaded spindle 122 and a spindle nut 124, is supported counter to the application direction 114 on the brake caliper 108. For this purpose, a support device 126 is provided, wherein the support device 126 has a ring-shaped body 128, a force-measuring device 130 and an axial bearing ring 132. In this case, the ring-shaped body 128 is supported counter to the application direction 114 on the brake caliper 108 via a bearing surface 134, while the axial bearing ring 132 is supported counter to the application direction 114 on the ring-shaped body 128 indirectly via the force-measuring device 130.

Along the application direction 114, a roller bearing 136 is furthermore arranged on the axial bearing ring 132, and a radial flange 138 of the threaded spindle 122 rests in turn on this roller bearing. In this case, the roller bearing 136 is designed as a two-row roller bearing.

During the operation of the brake device 100, the threaded spindle 122 is subjected to a torque by the electric motor 102. Since the spindle nut 124 arranged on the threaded spindle 122 is secured against rotation, a rotation of the threaded spindle 122 leads to a translation of the spindle nut 124 along the threaded spindle 122, or a torque acting on the threaded spindle 122 exerts a force on the spindle nut 124 along the threaded spindle 122 and consequently along the application direction 114. In this case, the pressure piston 112 with the friction lining 116 arranged thereon is secured on the spindle nut 124, with the result that subjecting the spindle nut 124 to a force in the application direction 114 leads to an application force acting on a brake disk.

The force exerted along the threaded spindle 122 during this process is supported counter to the actuation direction 114 by means of the support device 126 via the bearing surface 134 on the brake caliper 108. Here, the acting force is introduced into the force-measuring device 130 via the roller bearing 136 and the axial bearing ring 132, thus enabling the applied application force to be determined by appropriate design of the force-measuring device 130. Further details of this will be given below.

In order to achieve a defined initial level of the application force determined, even when the brake device 100 is unactuated, the support device 126 has a preloading device 140, which is formed by a clamping ring 142 in the form of a Belleville spring in the case illustrated. Here, the clamping ring 142 is secured along the application direction 114 by a retaining ring 144, wherein the retaining ring 144 is arranged in an encircling groove 146 in an inner wall 148 of the ring-shaped body 128. Here, the retaining ring 144 can be embodied as a snap ring, for example. In the radial direction, the extent of the clamping ring 142 is formed, on the one hand, by the inner wall 148 of the ring-shaped body 128 and, on the other hand, by a ring-shaped collar 150 formed on the axial bearing ring 132, wherein the ring-shaped collar 150 extends in the application direction 114. Consequently, the clamping ring 142 exerts a force which presses the axial bearing ring 132 onto the ring-shaped body 128 and consequently subjects the force-measuring device 130 arranged between the axial bearing ring 132 and the ring-shaped body 128 to a defined clamping force.

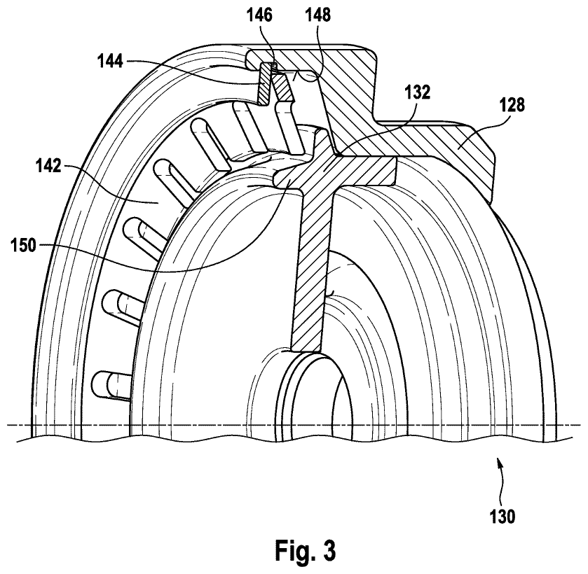

The arrangement described with reference to FIG. 2 is shown once again in FIG. 3 in a perspective illustration, wherein, for reasons of clarity, the threaded spindle 122, the spindle nut 124 and the roller bearing 136 are not illustrated.

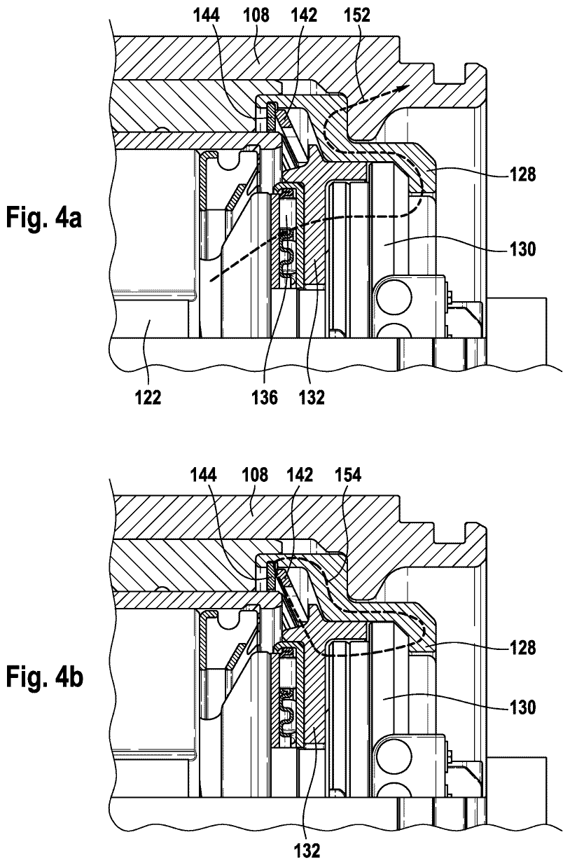

In FIG. 4, the respective force flows within the illustrated arrangement are illustrated once again with reference to the illustration in FIG. 2.

As shown in FIG. 4 a), a force 152 acting on the threaded spindle 122 is introduced into the axial bearing ring 132 via the roller bearing 136. Finally, via the force-measuring device 130 and the ring-shaped body 128, the force acting in this way is supported via the bearing surface 134 on the brake caliper 108.

FIG. 4 b) in turn shows the closed force circuit, which ensures a preload that acts on the force-measuring device. Here, the clamping ring 142 exerts a force 154 on the axial bearing ring 132, on the one hand, and, via the retaining ring 144, on the ring-shaped body 128, on the other hand. The force acting on the axial bearing ring 132 is, in turn, transferred to the force-measuring device 130, which is supported on the ring-shaped body 128. Consequently, the force circuit is closed in this case.

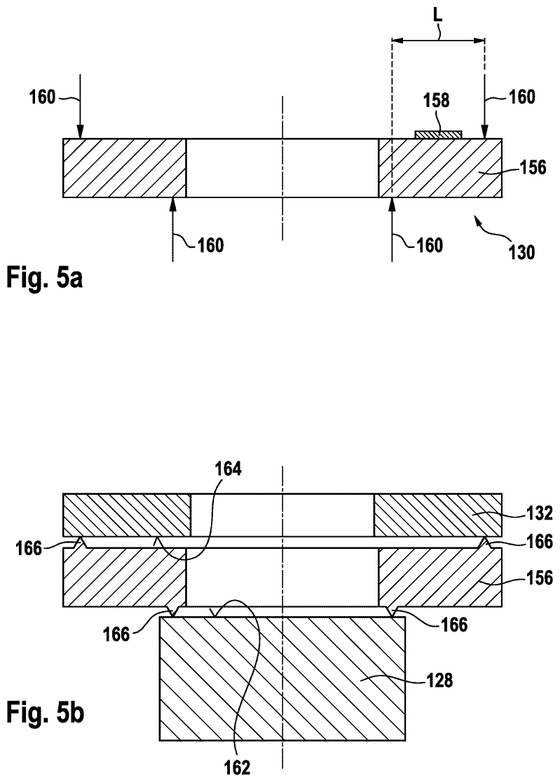

FIG. 5 shows a schematic illustration of the mode of operation of the force-measuring device 130. Here, FIG. 5 a) shows the force-measuring device 130 per se, wherein the force-measuring device 130 has a ring-shaped carrier body 156, on which a sensor device 158 in the form of strain gauges is arranged. Force introduction points 160 are furthermore illustrated schematically in FIG. 5 a). Owing to the radial offset by the length L of the force introduction points 160 above the carrier body 156 relative to the force introduction points 160 below the carrier body 156, a force exerted on the carrier body 156 via the force introduction points 160 leads to a bending moment and hence to a deformation of the carrier body 156. Here, the extent of this deformation can be determined by means of the sensor device 158 in the form of a change in length and can be converted directly into an acting force.

A specific implementation of this measurement principle is shown in FIG. 5 b). In this case, the axial bearing ring 132 and the ring-shaped body 128 are illustrated in addition to the force-measuring device 130, illustrated here by the carrier body 156. In this case, the carrier body 156 rests on a first bearing surface 162 of the ring-shaped body 128, on the one hand, and on a second bearing surface 164 of the axial bearing ring, on the other hand.

In this case, ring-shaped raised portions 166 in the form of ring-shaped jags which project in the axial direction and taper to a point are formed on the carrier body 156, wherein the carrier body 156 rests on the ring-shaped body 128 and the axial bearing disk 132 exclusively via the ring-shaped jags 166. In this case, the first ring-shaped jag 166, which faces the axial bearing ring 132, has a larger diameter than the second ring-shaped jag 166, which faces the ring-shaped body 128. In this way, the measurement principle illustrated in FIG. 5 a) is implemented.

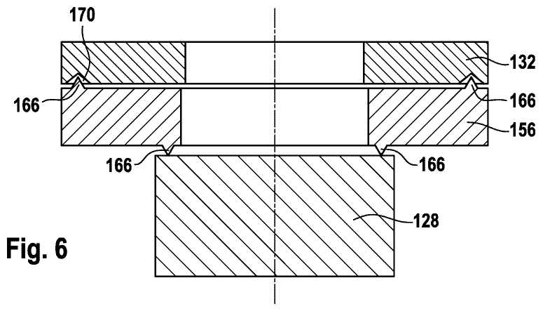

FIG. 6 shows a schematic illustration of an embodiment of the force-measuring device 130 of the kind described above with reference to FIG. 5. In this case, the groove 170 matched to the geometry of the first ring-shaped jag 166 is formed in the underside of the axial bearing ring 132, on the surface of the axial bearing disk 132 facing the carrier body 156. In this case, the ring-shaped jag 166 rests in the groove 170 on the axial bearing disk 132, thereby ensuring the correct alignment of the axial bearing disk 132 relative to the carrier body 156.

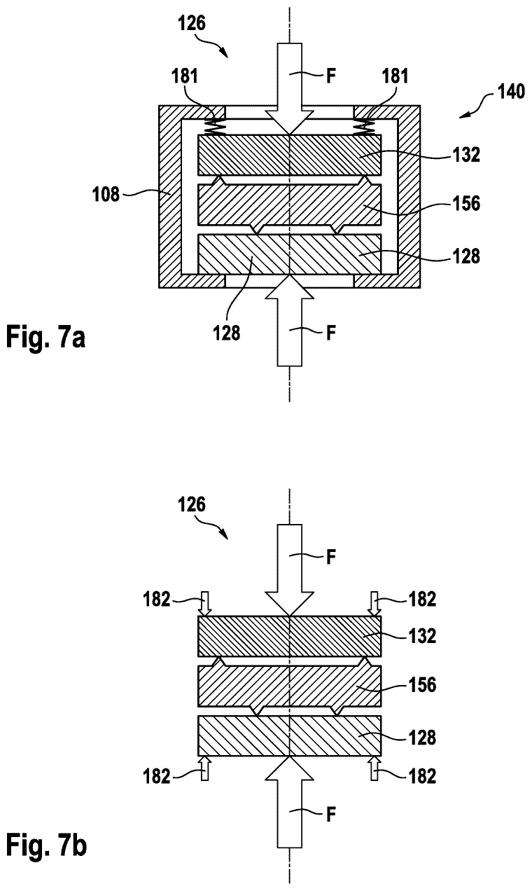

FIG. 7a shows a schematic sectional view of a support device 126 in a general illustration. The support device is arranged in a surrounding housing 108. This offers a good possibility for the arrangement of springs 181. The springs 181 are designed as compression springs and, in the exemplary embodiment, comprise a plurality of helical springs. The springs 181 are arranged between the housing 108 and the axial bearing ring 132, and between the housing 108 and the ring-shaped body 128. Support against the housing 108 enables the preloading force to be applied to the support device 180 by means of the springs 181. For uniform application of the preloading force, a plurality of springs 181 can be provided, which can be positioned at uniform intervals relative to one another and/or at the same distance from a central point, e.g. in a regular arrangement. After installation and preloading, the support device 126 can be subjected to a force F during operation. For greater clarity, FIG. 7a shows only some essential elements of the support device 126; thus, for example, the force-measuring device is not included in the illustration.

FIG. 7b shows another schematic sectional view of the support device 126 from FIG. 7a, wherein, for the sake of clarity, the housing 108 has been omitted and, instead, the force introduction points 182 for the application of the preloading force have been inserted.

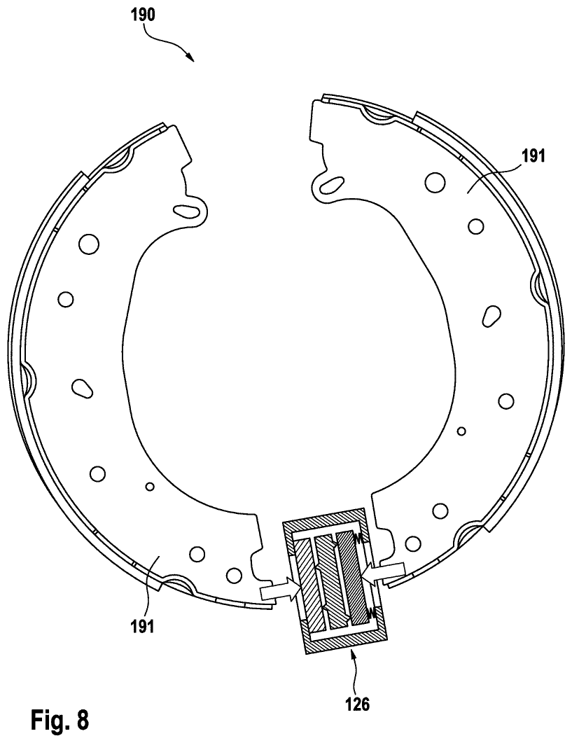

FIG. 8 shows a schematic sectional view of part of a drum brake 190 with a support device 126 according to the invention. In this exemplary embodiment, the support device 126 is arranged between two brake shoes 191. For the sake of clarity, other components are not depicted.

The embodiments accordingly provides an electromechanical brake device 100 for a motor vehicle, having:
an electric motor drive 102 for the provision of a torque,
a transmission assembly 106 for converting the torque into an application force acting along the application direction 114 of the brake device 100,
a support device 126 for supporting the transmission assembly 106 counter to the application direction 114, and
a clamping device 120 for converting the force acting along the application direction 114 into a clamping force acting on an element to be decelerated,
characterized in that
the support device 126 has a force-measuring device 130 for measuring a force acting on the support device 126 along the application direction 114, wherein the support device 126 has a preloading device 140, wherein, even in the absence of a force generated by the electric motor drive 102 together with the transmission assembly 106 and acting along the application direction 114, the preloading device 140 subjects the force-measuring device 130 to a force acting along the application direction 114.

The electromechanical brake device 100 specified above is furthermore characterized in that the transmission assembly 106 has a spindle drive with a threaded spindle 122 and a spindle nut 124 secured against rotation about the threaded spindle 122, wherein the spindle nut 124 is supported counter to the application direction 114 on the support device 126.

The electromechanical brake device 100 specified above is furthermore characterized in that a roller bearing 136 is arranged between the axial bearing ring 132 and the threaded spindle 122, wherein the threaded spindle 122 is supported counter to the application direction 114 on the roller bearing 136.

The electromechanical brake device 100 specified above is furthermore characterized in that a clamping ring 142 is arranged between the ring-shaped body 128 and the axial bearing ring 132, wherein the clamping ring 142 subjects the axial bearing ring 132 to a force in the direction of the force-measuring device 130.

The electromechanical brake device 100 specified above is furthermore characterized in that the clamping ring 142 is secured along the application direction 114 by a retaining ring 144, wherein the retaining ring 144 is arranged at least partially in an encircling groove 146 in an inner wall 148 of the ring-shaped body 128.

The electromechanical brake device 100 specified above is furthermore characterized in that an encircling ring-shaped collar 150 is formed on the axial bearing ring 132, wherein the ring-shaped collar 150 extends in the application direction 114 and delimits the radial extent of the clamping ring 142.

The electromechanical brake device 100 specified above is furthermore characterized in that the force-measuring device 130 has a carrier body 156, wherein the carrier body 156 rests, on the one hand, on a first bearing surface 162 of the ring-shaped body 128 and, on the other hand, on a second bearing surface 164 of the axial bearing ring 132, wherein a sensor device 158 is arranged on or in the carrier body 156, wherein the sensor device 158 is designed to measure a deformation of the carrier body 156 due to the action of a force.

The electromechanical brake device 100 specified above is furthermore characterized in that raised portions 166 that project in the axial direction and taper to a point in the axial direction are formed on the carrier body 156, wherein a first one of the raised portions 166 is formed on a surface of the carrier body 156 which faces the axial bearing ring 132, and a second of the raised portions 166 is formed on a surface of the carrier body 156 which faces the ring-shaped body 128, wherein the geometry of the first raised portion 166 differs from the geometry of the second raised portion 166.

The electromechanical brake device 100 specified above is furthermore characterized in that a groove 170 matched to the geometry of the first raised portion is formed in the axial bearing ring 132 on the surface facing the carrier body 156, wherein the first raised portion 166 is supported in the groove 170.

1. A support device for supporting a transmission assembly of an electromechanical brake device for a motor vehicle comprising:
a clamping device for converting the force acting along an application direction into a clamping force acting on an element to be decelerated,
a force-measuring device for measuring a force acting on the support device along the application direction, and
a preloading device, wherein the preloading device together with the transmission assembly subjects the force-measuring device to a force acting along the application direction even in the absence of a force generated by the electric motor drive.

2. The support device as claimed in claim 1, wherein the preloading device comprises at least one spring element, which is designed to apply a preloading force in the axial direction.

3. The support device as claimed in claim 1, wherein the spring element comprises at least one compression spring.

4. The support device as claimed claim 1, wherein the support device has a ring-shaped body and an axial bearing ring, wherein the ring-shaped body is supported counter to the application direction on a housing of the brake device, and wherein the axial bearing ring is supported counter to the application direction on the ring-shaped body via the force-measuring device.

5. The support device as claimed in claim 1, wherein a clamping ring is arranged between the ring-shaped body and the axial bearing ring, wherein the clamping ring subjects the axial bearing ring to a force in the direction of the force-measuring device.

6. The support device as claimed in claim 5, wherein the clamping ring is secured along the application direction by a retaining ring, wherein the retaining ring is arranged at least partially in an encircling groove in an inner wall of the ring-shaped body.

7. The support device as claimed in claim 1, wherein an encircling ring-shaped collar is formed on the axial bearing ring, wherein the ring-shaped collar extends in the application direction and delimits the radial extent of the clamping ring.

8. The support device as claimed in claim 1, wherein the transmission assembly has a spindle drive with a threaded spindle and a spindle nut secured against rotation about the threaded spindle wherein the spindle nut is supported counter to the application direction on the support device.

9. The support device as claimed in claim 8, wherein a roller bearing is arranged between the axial bearing ring and the threaded spindle, wherein the threaded spindle is supported counter to the application direction on the roller bearing.

10. The support device as claimed in claim 1, wherein the force-measuring device has a carrier body, wherein the carrier body rests on a first bearing surface of the ring-shaped body and on a second bearing surface of the axial bearing ring, wherein a sensor device is arranged on or in the carrier body, wherein the sensor device is designed to measure a deformation of the carrier body due to the action of a force.

11. The support device as claimed in claim 10, wherein raised portions that project in the axial direction and taper to a point in the axial direction are formed on the carrier body, wherein a first one of the raised portions is formed on a surface of the carrier body which faces the axial bearing ring, and a second of the raised portions is formed on a surface of the carrier body which faces the ring-shaped body, wherein the geometry of the first raised portion differs from the geometry of the second raised portion.

12. The support device as claimed in claim 11, wherein a groove matched to the geometry of the first raised portion is formed in the axial bearing ring on the surface facing the carrier body, wherein the first raised portion is supported in the groove.

13. An electromechanical brake device for a motor vehicle comprising:
an electric motor drive for the provision of a torque,
a transmission assembly for converting the torque into an application force acting along the application direction of the brake device, and
a support device, for supporting the transmission assembly counter to the application direction comprising:
a clamping device for converting the force acting along an application direction into a clamping force acting on an element to be decelerated,
a force-measuring device for measuring a force acting on the support device along the application direction, and
a preloading device, wherein the preloading device together with the transmission assembly subjects the force-measuring device to a force acting along the application direction even in the absence of a force generated by the electric motor drive.

14. The electromechanical brake device as claimed in claim 13, wherein the brake device is one of a disk brake, and a floating caliper disk brake.

15. The electromechanical brake device as claimed in claim 13, wherein the brake device is a drum brake.

16. The support device as claimed in claim 3, wherein the at least one compression spring, is at least one of a helical spring and a Belleville spring.
